(19) United States
(12) Patent Application Publication
(10) Pub. No.: US 2011/0052961 A1
(43) Pub. Date: Mar. 3, 2011

(54) Battery With a Heat Conducting Plate and Several Individual Cells

(75) Inventors: Arnold Lamm, Elchingen (DE); Jens Meintschel, Bernsdorf (DE); Dirk Schroeter, Winnenden (DE); Wolfgang Warthmann, Weinstadt (DE)

(73) Assignee: Daimler AG, Stuttgart (DE)

(21) Appl. No.: 12/918,602

(22) PCT Filed: Feb. 19, 2009
(86) PCT No.: PCT/EP2009/001178

§ 371 Date: Nov. 12, 2010

(30) Foreign Application Priority Data
Feb. 23, 2008 (DE) 10 2008 010 825.1

(51) Int. Cl. H01M 10/50

(52) U.S. Cl. 429/120

(57) ABSTRACT

In a battery with a heat-conducting plate and several individual cells that are combined into a cell combination, wherein with pole contacts of the individual cells electrically interconnected in parallel and/or in series. The cell compound and the heat-conducting plate are completely surrounded by a clamping element. A contact plate is arranged between the first individual cell and the clamping elements and at the face side between the last individual cell and the clamping elements.

This application is a national stage of PCT International Application No. PCT/EP2009/001178, filed Feb. 19, 2009, which claims priority under 35 U.S.C. §119 to German Patent Application No. 10 2008 010 825.1, filed Feb. 23, 2008, the entire disclosure of which is herein expressly incorporated by reference.

### BACKGROUND AND SUMMARY OF THE INVENTION

The invention relates to a battery with a heat-conducting plate and a plurality of individual cells that are combined to form a cell compound, with pole contacts of the individual cells electrically interconnected in parallel and/or in series. The cell compound and the heat-conducting plate are completely surrounded by a clamping element, and a contact plate is arranged between the first individual cell and the clamping elements and at the face side between the last individual cell and the clamping elements.

A battery with several individual cells is known, whose pole contacts are interconnected with each other electrically and/or in parallel and form a cell compound. Furthermore, a heat-conducting plate is provided for cooling the battery, which discharges lost heat developing in the battery. At least the cell compound and the heat-conducting plate are arranged in a housing frame, which is especially formed as a clamping element, and completely surrounds the cell compound and the heat-conducting plate. Furthermore, an electrical connection element is arranged respectively at a first housing side wall of a first individual cell and a housing side wall of a last individual cell of the cell compound, for electrical contacting of the battery.

Such batteries have the disadvantage that the first and last individual cells are strained intensely by means of the clamping element which completely surrounds the at least one cell compound and the heat-conducting plate.

One object of the invention, therefore is to provide an improved battery, which overcomes the above deficiencies in the state of the art, and which can be produced in a simple and cost-efficient manner.

This and other objects and advantages are achieved by the battery according to the invention, which has a plurality of individual cells that are combined to form a cell compound, and a heat-conducting plate for temperature control. Pole contacts of the individual cells are thereby electrically interconnected in parallel or in series. The cell compound and the heat-conducting plate are completely surrounded by clamping elements, with an electrical connection element arranged at the end faces of the first and last individual cells. According to the invention, a contact plate is respectively arranged at the end face between the first individual cell of the cell compound and the clamping elements and at the end face between the last individual cell and the clamping elements.

A cell compound is thereby formed in an advantageous manner, with which a safe series connection is provided as a result of the high contact forces generated by the contact plates and acting on the cell compound. Furthermore, preferably no tensions act on the first and the last individual cell of the cell compound, as mechanical strains acting on the cell compound and forces resulting therefrom are received and distributed by the contact plates evenly over their entire surface. A production of more robust individual cells is enabled thereby, in which the forces acting through the clamping elements can be largely compensated by means of the contact plates. A mechanical strain of the individual cells is thus largely avoided in a safe manner.

In a particularly advantageous manner, the contact plates are electrically conductive at least at one contact side, which is directed towards the cell compound. The contact sides are designed in a metallic manner for this, for example by applying a metallic film. As the contact plates are formed electrically at the contact side, they simultaneously form the electrical connection elements in a particularly preferred manner. The costs and the assembly effort of the battery are thus reduced, as no additional components are necessary for the electrical connection.

The contact plates have on at least one side thereof tab-like extensions which form the poles of the battery in an advantageous manner, through which a voltage can be taken out. One pole is for example formed as a positive pole and the other pole as a negative pole.

Furthermore, an electronic component is arranged at the top side to the individual cells, which has recesses corresponding to the tab-like extensions in an advantageous manner, whereby a form-fit assembly of the battery is ensured.

The contact plates further have material recesses, which correspond especially preferred to the dimensions, especially to a width of the clamping elements. By means of this correspondence, which is formed as a type of guide of the clamping elements, a force-fit pressing together of at least the individual cells of the cell compound can be realized.

In a particularly advantageous manner, the height and the width of the contact plates correspond to the dimensions of an individual cell.

In a further arrangement of the invention, the individual cells and/or the pole contacts of different individual cells are connected to each other in a force-fit, form-fit and/or material-fit manner. A durable electrical contact is thereby ensured between the pole contacts of the individual cells in a simple manner.

The individual cells are additionally formed of an electrode stack arranged in a cell housing, wherein at least electrodes of different polarity are separated from each other by a separator, preferably a separator film in an insulating manner.

In a particular manner, an edge region of the respective electrode film guided to the outside of the electrode stack forms a current drain tab, so that an elaborate contacting of electrode film and current drain tab is unnecessary. This type of contacting is at the same time very safe against at least many, in particular influences, such as impacts or vibrations.

Current drain tabs with the same polarity are connected in an electrically conductive manner to a pole. Current drain tabs of a pole are further pressed together and/or welded in an electrically conductive manner.

By an arrangement of the electrode stack in a in particularly electrically insulating frame which passes around the edge side, an additional insulating arrangement can be saved in an advantageous manner. The manipulation of the individual cell is further eased or designed in a safer manner.

The contacting of the current drain tabs takes place directly to the opposite housing side walls of the cell housing, in particular with bipolar individual cells in a particular manner, wherein these housing side walls are electrically insulated from each other by means of the frame. In this manner, current drain tabs with the same polarity are electrically connected directly to a housing side wall of the cell housing, in particular of a flat cell, so that the housing side walls form the electrical pole contacts of the individual cell. The pressure tightness of the cell housing of the individual cell is also not weakened, as a contact feed-through of the poles does not take place. The improvement of the tightness of the interior of the cell housing with regard to a passage of humidity is hereby also connected directly.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic perspective view of a battery according to the state of the art;

FIG. 2 is an exploded perspective view of a battery with contact plates arranged at the cell compound at the face side;

FIG. 3 is a schematic perspective view of a battery with contact plates arranged at the cell compound according to the invention;

FIG. 4 is a schematic sectional view of a cell compound with a heat-conducting plate arranged at the bottom side and contact plates arranged at the face side;

FIG. 5 is an exploded perspective view of a cell compound with contact plates arranged at the face side;

FIG. 6 is a schematic side view of a cell compound with contact plates arranged at the face side according to FIG. 4.

### DETAILED DESCRIPTION OF THE DRAWINGS

Parts corresponding to each other are provided with the same reference numerals in all figures.

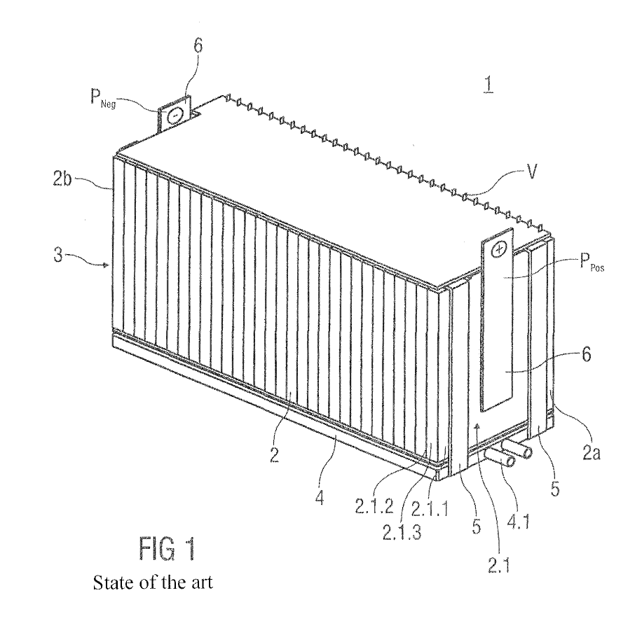

FIG. 1 shows a battery 1 according to the state of the art, which is formed of several individual cells 2 that are combined to form a cell compound 3.

The individual cell 2 is formed as a flat cell, in particular a frame flat cell. A cell housing 2.1 of the individual cell 2 is thereby formed from two housing side walls 2.1.1 and 2.1.2 and a frame 2.1.3 arranged between them passing around the edge side.

The housing side walls 2.1.1 and 2.1.2 of the individual cell 2 are electrically conductive and form pole contacts (not shown in detail) of the individual cell 2. The frame 2.1.3 is designed in an electrically insulating manner, so that the housing side walls 2.1.1 and 2.1.2 with different polarity are arranged in an electrically insulating manner.

In the shown embodiment of the invention, a housing side wall 2.1.1 and 2.1.2 has a partial extension V, which projects over the individual cell 2, and serves for cell voltage monitoring.

The cell compound 3 and a heat-conducting plate 4 arranged on the bottom side to the individual cells 2 are completely surrounded by two clamping elements 5, which at least press the individual cells 2 of the cell compound 3 together in a force-fit manner. Due to the acting forces, which are generated by the clamping elements 5, in the battery according to the prior art, a first individual cell 2a and a last individual cell 2b, which are respectively arranged at the face side in the cell compound 3, are strained particularly intensely.

For removing and/or supplying electrical energy from and/or into the battery 1, an electrical connection element 6 is arranged at a cell side wall of the first individual cell 2a of the cell compound 3. This connection element 6 is designed as an electrical connection tab and forms the positive pole P_{POS} of the battery 1.

At the cell side wall of the last individual cell 2b of the cell compound 3 is arranged a further electrical connection element 6. This connection element 6 is also designed as an electrical connection tab and forms the negative pole P_{NEG} of the battery 1.

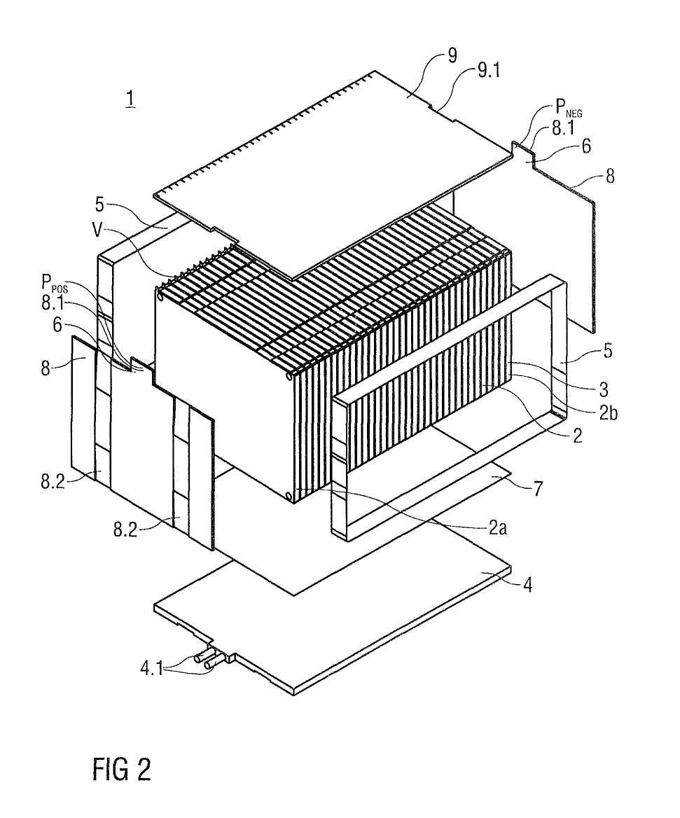

FIG. 2 shows a battery 1, which is suitable, for example, for use in a vehicle, in particular a hybrid and/or electric vehicle.

The battery 1, in particular the cell compound 3, is thereby for example formed of thirty individual cells 2. The individual cells 2, which are designed as frame flat cells, are in particular interconnected in series via their pole contacts.

The heat-conducting plate 4 is arranged on the bottom side to the individual cells 2 for the temperature control of the battery 1. The heat-conducting plate 4 has connection locations 4.1, by which they can, for example, be connected to an air-conditioning cycle of a vehicle. The housing side walls 2.1.1 and 2.1.2 are angled in parallel in the region of the heat-conducting plate 4 thereto for increasing a heat transfer surface between the individual cell 1 and the heat-conducting plate 4. The individual cells 2 are thereby coupled directly or indirectly in a thermal manner to the heat-conducting plate 4 by a heat-conductive material, in particular a heat-conducting film 7, so that an effective cooling of the battery is achieved.

According to the invention, a contact plate 8 is respectively arranged at the face side between the first individual cell 2a of the cell compound 3 and the clamping elements 5 and at the face side between the last individual cell 2b and the clamping elements 5.

By means of the high contact forces generated by the contact plates, a cell compound is formed in a particularly preferred manner, whereby a safe series connection can be realized. Furthermore, mechanical forces acting on the first individual cell 2a and the last individual cell 2b of the cell compound 3 are distributed evenly and over the entire surface of the contact plate 8.

The contact plates 8 are furthermore electrically conductive at least at one contact side to the cell compound 3. The contact side of the contact plate 8 can for example be provided with a metallic film for this.

In an advantageous arrangement of the battery 1, the contact plates 8 form the electrical connection elements 6, as shown in FIG. 2. The contact plates 8 have tab-like extensions 6.1 at one side for this. These tab-like extensions 8.1 are designed in an advantageous manner as the poles of the battery 1, via which a voltage of the battery 1 can be taken out. One pole is thereby for example formed as a positive pole p_{POS} and the other pole as a negative pole p_{NEG} of the battery 1. In order to improve an electrical conductivity between the contact side of the contact plate 8 and the first individual cell 2a and the last individual cell 2b, a film, which is e.g., made of nickel, can be provided and be arranged between the contact plates and the first individual cell 2a and the last individual cell 2b.

In the shown embodiment of the invention, an electronic component 9 is provided, which has at least devices for the cell voltage monitoring and/or to a cell voltage balancing of the individual cells 2, not shown in detail. In order to monitor the cell voltage, the partial extension V of the housing side wall 2.1.1 and 2.1.2 is formed at the individual cells 2. The electronic component 9 can also be formed as an encapsulated electronic component in a continuation of the invention. The electronic component is thereby arranged at the top side to the cell compound 3 and has recesses 9.1 corresponding to the tab-like extensions 8.1, in particular the poles P_{POS} and P_{NEG} of the contact plates 8. A form-fit assembly of the battery 1 is ensured by the recesses 9.1.

The contact plates 8 further have material recesses 8.2 in a particularly preferred manner, which correspond to the clamping elements 5, in particular a thickness, of the clamping elements 5. By means of this correspondence, which is formed as a type of guide of the clamping elements 5, a safe pressing together of at least the individual cells 2 of the cell compound can be realized, so that the individual cells are held in a form-fit and force-fit manner.

In a particularly advantageous manner, the height and width extension of the contact plate 8 correspond especially preferred to the dimensions of an individual cell 2 in particular a face side of the cell compound 3.

In that the material recesses 8.2 are formed as a type of guide, a safe force-fit pressing together of the cell compound 3 can be realized in an advantageous manner.

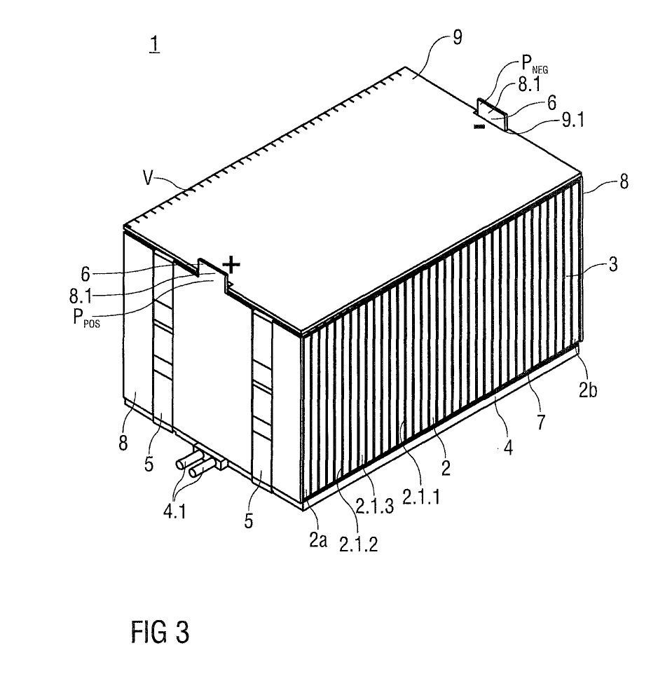

FIG. 3 shows an assembled battery 1 with contact plates 8 arranged at the first individual cell 2a and at the last individual cell 2b of the cell compound 3.

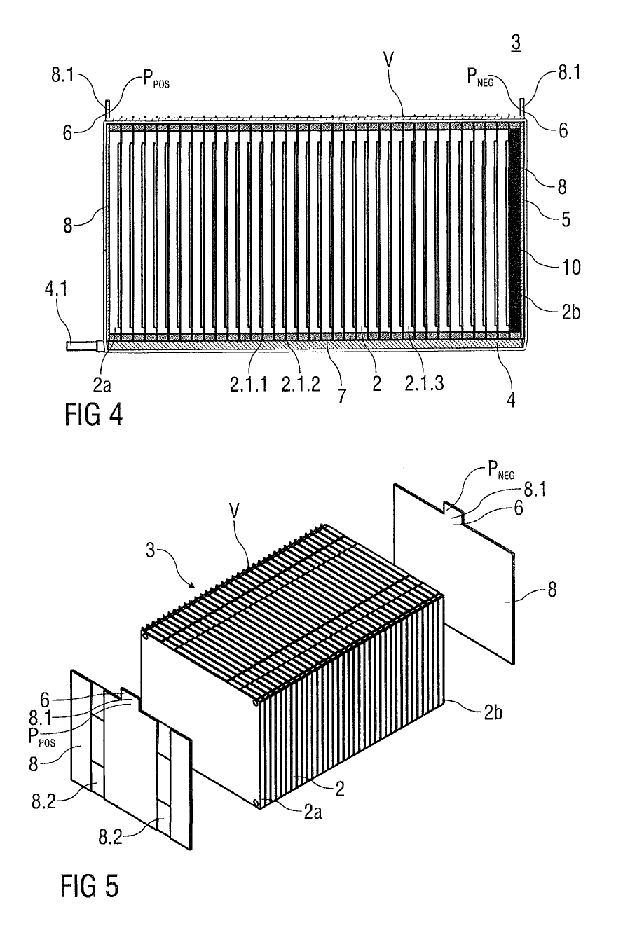

FIG. 4 shows a sectional view of the cell compound 3 with a contact plate 8 that is respectively arranged at the face side.

An electrode stack 10, which is formed of electrode films, not shown in detail, arranged in a cell housing 2.1 of an individual cell 2 is shown thereby.

In a center region, the electrode films with different polarity, in particular aluminum and/or copper films and/or films of a metal alloy, are stacked above each other and are insulated electrically by means of a separator, in particular a separator film (not shown in detail).

Electrode films with the same polarity are electrically connected to each other in an edge region of the electrode films projecting over the center region of the electrode stack 10. The current drain tabs are thereby pressed together or welded in an electrically conductive manner and form the poles of the electrode stack 10. The electrode stack 10 is arranged in the frame passing around the electrode stack 10 on the edge side.

With a fastening of the housing side walls 2.1.1 and 2.1.2, which takes place for example in a manner not shown in detail by means of adhesion and/or flanging the housing side walls 2.1.1 and 2.1.2 in a recess passing around in the frame 2.1.3, the poles formed from the current drain tabs are pressed against the housing side walls 2.1.1 and 2.1.2, so that an electrical potential of the current drain tabs is applied at the housing side walls 2.1.1 and 2.1.2 and these form the pole contacts of the individual cell 2.

In a further development of the invention, a film, not shown in detail, which is e.g., made of nickel, can additionally be arranged between the poles, which are e.g., made of copper and the housing side walls 2.1.1 and 2.1.2, which are e.g., made of aluminum, in order to achieve an improved connection between the poles and the housing side walls 2.1.1 and 2.1.2.

In one arrangement of the invention, it is furthermore possible to arrange an electrically insulating film, not shown in detail, between the poles and the housing side walls 2.1.1 and 2.1.2 or to design the housing side walls 2.1.1 and 2.1.2 on one side with an electrically insulating layer, so that an electrical contacting of the poles with the housing side walls 2.1.1 and 2.1.2 results only with a full penetration welding in a manner known from the state of the art, from the outside through the housing side walls 2.1.1 and 2.1.2.

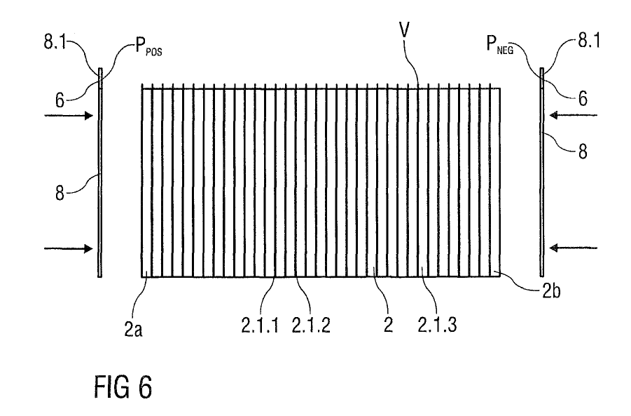

FIGS. 5 and 6 show respective different views of the cell compound 3 with contact plates 8 arranged at the face side.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Battery
2 Individual cell
   2a first individual cell
   2b last individual cell
   2.1 Cell housing
   2.1.1 Housing side wall
   2.1.2 Housing side wall
   2.1.3 Frame
3 Cell compound
4 Heat-conducting plate
   4.1 Connection locations
5 Clamping elements
6 electrical connection element
7 Heat-conducting film
8 Contact plate
   8.1 tab-like extension
   8.2 Material recess
9 electronic component
   9.1 Recesses
10 Electrode stack
P_{POS} positive pole
P_{NEG} negative pole
V partial extension

1.-15. (canceled)

16. A battery comprising:
a plurality of individual cells that are combined into a cell compound, with pole contacts of the individual cells being electrically interconnected in at least one of a parallel and a series configuration;
a heating-conducting plate;
clamping elements that completely surround the cell compound and the heat-conducting plate;
an electrical connection element arranged at a face side at a first individual cell and at a last individual cell, of the cell compound; and
respective contact plates arranged between the first individual cell and the clamping elements at the face side, and between the last individual cell and the clamping elements at the face side.

17. The battery according to claim 16, wherein the contact plates are electrically conductive, at least at one contact side to the cell compound.

18. The battery according to claim 16, wherein the contact plates form the electrical connection elements.

19. The battery according to claim 16, wherein the contact plates have tab-like extensions.

20. The battery according to claim 19, wherein the tab-like extensions form poles of the battery.

21. The battery according to claim 19, wherein an electronic component arranged at the top side to the individual cells has recesses corresponding to the tab-like extensions.

22. The battery according to claim 16, wherein the contact plates have material recesses corresponding to the dimensions of the clamping elements.

23. The battery according to claim 16, wherein the contact plates correspond to the dimensions of an individual cell in their height and width extension.

24. The battery according to claim 16, wherein the individual cells are connected to each other in a force-fit, form-fit and/or material-fit manner.

25. The battery according to claim 16, wherein the pole contacts of different individual cells are connected to each other in a force-fit, form-fit and/or material-fit manner.

26. The battery according to claim 16, wherein an electrode stack is arranged in a cell housing whose individual electrodes are connected to each other in an electrically conductive manner with current drain tabs.

27. The battery according to claim 26, wherein said individual electrodes comprise electrode films.

28. The battery according to claim 26, wherein current drain tabs with the same polarity are connected to a pole contact in an electrically conductive manner.

29. The battery according to claim 26, wherein the current drain tabs of a pole contact are pressed and/or welded to each other in an electrically conductive manner.

30. The battery according to claim 26, wherein the cell housing has two housing side walls and a frame arranged between them, which passes around at the edge side.

31. The battery according to claim 26, wherein the housing side walls are electrically conductive and the frame is electrically insulating.
